(19) United States
(12) Patent Application Publication
(10) Pub. No.: US 2014/0204042 A1
(43) Pub. Date: Jul. 24, 2014

(54) DISPLAY CONTROL SYSTEM AND CONTROL METHOD THEREOF

(71) Applicant: YOMORE TECHNOLOGY CO., LTD, Kaohsiung City (TW)

(72) Inventors: Jao-Ching Lin, KAOHSIUNG CITY (TW); Wen-Ting Lee, KAOHSIUNG CITY (TW)

(73) Assignee: YOMORE TECHNOLOGY CO., LTD, Kaohsiung City (TW)

(21) Appl. No.: 14/157,442

(22) Filed: Jan. 16, 2014

(30) Foreign Application Priority Data
Jan. 18, 2013 (TW) 102101932

(51) Int. Cl. G06F 3/041

(52) U.S. Cl. CPC G06F 3/041
USPC 345/173

(57) ABSTRACT

A display control system includes a display device and a portable device. The display device includes a display interface having a controllable object. The portable device includes a communication unit, a touch interface and a transmission unit. The communication unit transmits voice signals to third party communication devices and receives voice signals from said third party communication devices. The touch interface generates a touch signal containing a position data that corresponding to a position of a touch point on the display interface. The transmission unit transmits the touch signal to the display device for moving the controllable object on the display interface to a position that corresponding to the position of the touch point on the touch interface.

### BACKGROUND OF THE INVENTION

1. Field of the Invention

The present invention relates to a display control system, and more particularly, to a display control system which utilizes a portable device to control a display device.

2. Description of the Prior Art

Display devices are disposed with control devices such as a remote control for a TV, buttons installed on a display panel, a wireless keyboard/mouse for a monitor, etc. However, these controllers all have their own shortcomings. For example, a remote control has number keys and directional keys, but it cannot enter text nor can it control a cursor like a mouse, hence a user can not use it to input any desirable data. Further a remote control cannot be customized according to a user's request such as setting a favorite channel and controlling a plurality of display devices with only a remote control. That is, controls of a plurality of devices cannot be integrated into a single remote control. Hence, a user must use a plurality of remote controls to control their corresponding display devices. As the number of functions of a remote control increases, the number of buttons disposed on the remote control has to be increased correspondingly, increasing the size of the remote control.

In another example, though a user can use control buttons such as directional keys to select items in a list displayed on a display panel, the user cannot enter numbers or text, nor can the user control a cursor. Thus the operation interface is quite inflexible. Further the control buttons cannot be customized according to the user's request, nor can the control buttons be used to control a plurality of devices. The control buttons are fixed at a certain position, they cannot be moved with the user, nor are they portable, thus cannot control the display panel remotely. Further as the number of functions of the control buttons increases, the number of control buttons disposed on the remote control has to be increased correspondingly, increasing the space occupied by the control buttons.

In yet another example, though a wireless keyboard can enter text or numbers, and a wireless mouse can control a cursor and can select an item on a list, the user has to switch between the keyboard and the mouse, and the keyboard and the mouse cannot be customized, nor can they be used to control a plurality of devices. And they occupy a lot more space than a remote control.

In addition to the aforementioned shortcomings, a user can not use a finger to continuously move an object on a display device with the above control devices intuitively. That is, the object or cursor on the display device is moved grid by grid, not sliding with the user's finger. Further the object or document on the display device cannot be quickly selected, nor can multiple functions such as tap, drag, scroll, handwriting, drawing by hand, etc. be performed on the object. FIG. 8 shows shortcomings of the prior art control devices.

As shown above, prior art control devices have their own shortcomings. The control devices are designed specifically for their corresponding display devices. Thus extra material and cost are wasted to produce the control devices, and they occupy a lot of additional space. It is therefore necessary to find a solution to overcome the shortcomings and find a more user friendly approach to control the display device.

### SUMMARY OF THE INVENTION

An embodiment of the present invention discloses a display control system for controlling a display device comprising a display interface having a controllable object. The display control system comprises a communication unit, a touch interface and a transmission unit. The communication unit is configured to transmit voice signals to third party communication devices and receive voice signals from said third party communication devices. The touch interface is configured to generate a touch signal containing a position data that corresponding to a touch point on the display interface. The transmission unit is connected with the touch interface and being configured to transmit the touch signal to the display device for moving the controllable object on the display interface to a position that corresponding to the position of the touch point on the touch interface.

Another embodiment of the present invention discloses a method for controlling a display device with a display interface displaying a controllable object, the method comprising: generating, by at least one portable device, a touch signal containing a position data that corresponding to a position of a touch point on the display interface; and receiving the touch signal, on the display device, to move the controllable object on the display interface to a position that corresponding to the position of the touch point on the touch interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a display control system according to an embodiment of the present invention.

FIG. 2 shows the portable device being used to control the display device in FIG. 1 when the display device displays a TV program.

FIG. 3 shows the portable device placed horizontally to control the display device in FIG. 1.

FIG. 4 shows that the portable device controls the display device in FIG. 1 in a gesture mode.

FIG. 5 shows a display control system according to another embodiment of the present invention.

FIG. 6 shows a display control system according to another embodiment of the present invention.

FIG. 7 shows a comparison between the portable device of the present invention and prior art control devices.

FIG. 8 shows shortcomings of prior art control devices.

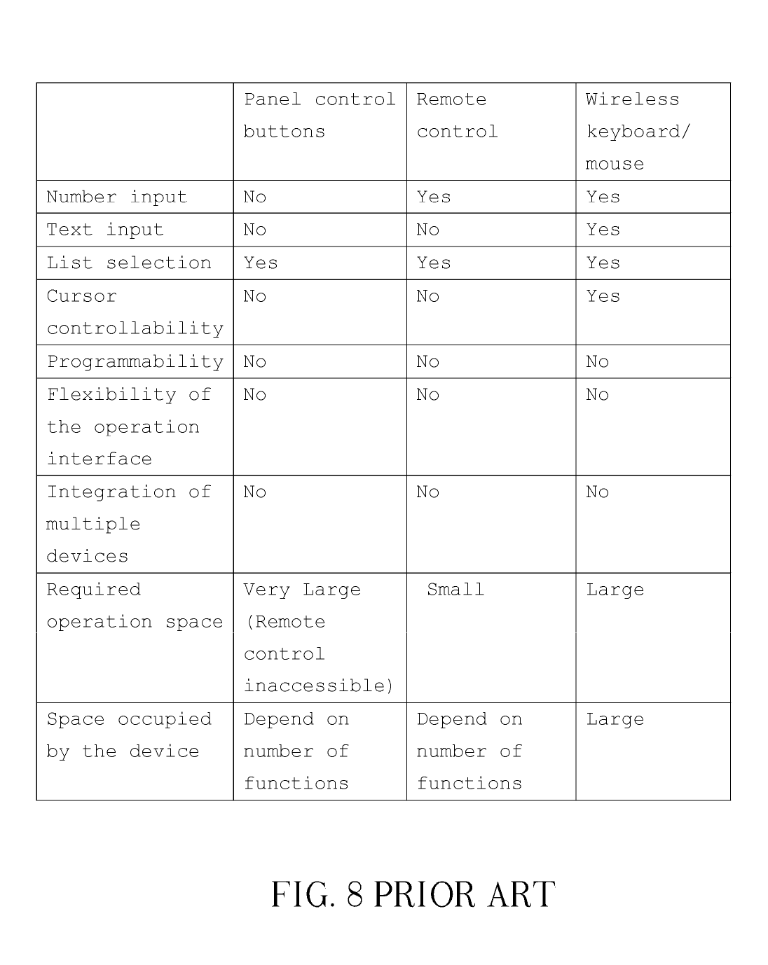

### DETAILED DESCRIPTION

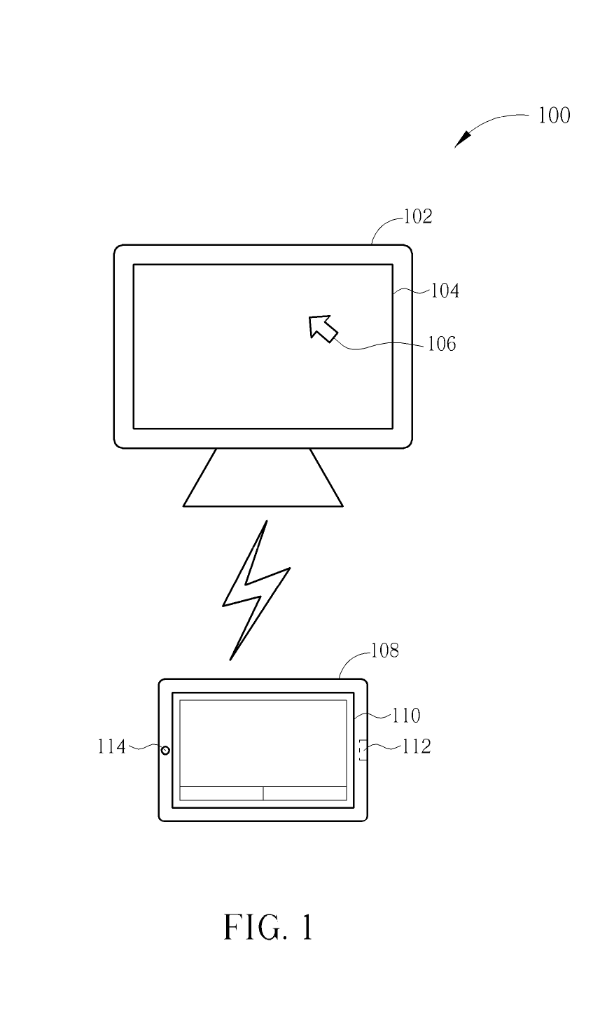

FIG. 1 shows a display control system 100 according to an embodiment of the present invention. The display control system 100 comprises a display device 102 and at least one portable device 108. The display device 102 includes a display interface 104. A controllable object 106 is displayed on the display interface 104. The controllable object 106 can be a cursor or another type of pointer. The portable device 108 comprises a touch interface 110, a transmission unit 112 and a communication unit 114. The touch interface 110 is configured to generate a touch signal containing a position data that corresponding to a position of a touch point on the display interface 104. The transmission unit 112 is configured to transmit the touch signal to the display device 102 for moving the controllable object 106 on the display interface 104 to a position that corresponding to the position of the touch point on the touch interface 110. The communication unit 114 is configured to transmit voice signals to third party communication devices and receive voice signals from said third party communication devices, so that a user can use the portable devices 108 to make voice communications with third party communication devices. The portable device 108 can perform wireless communications with the display device 102 via Wi-Fi, Bluetooth, infrared, or an Ethernet network so as to control the display device 102. The portable device 108 can be a smartphone, a cellular phone, a wireless keyboard or a mobile electronic device with a touch interface. A smartphone is used below as the portable device 108 to explain the operation method of the display control system 100.

In a smartphone, a user can install control software for the touch interface 110. The control software can be application software or a driver, or can be used to update firmware of the touch interface 110. After installing the control software, when the user operates the touch interface 110, the touch interface 110 generates a touch signal containing a position data that corresponding to a position of a touch point on the display interface 104, and the control software can convert the touch signal to a control signal and then send the control signal to the display device 102 via a previously established communication mechanism, such as a wireless communication mechanism.

After receiving the control signal, the display device 102 operates correspondingly. For instance, the controllable object 106 moves to coordinates of a touch point on the display interface 104 according to the touch signal generated by the user's operation on the touch interface 110. In this way, a user can control the portable device 108 to select options displayed on the display device 102 such as to adjust audio volume, switch channels, and play/pause an audio/video program. In order to perform the mentioned operations on the display device 102, the user can set the portable device 108 in various operation modes. That is, the portable device 108 has a flexible operation interface enabling the user to switch the operation mode easily.

For example, when the user switches the portable device 108 to a number input mode, a virtual number pad is displayed on the display interface 104 of the display device 102. The user can move his/her finger on the touch interface 110 of the portable device 108 to drag the controllable object 106 displayed on the display interface 104 to a target number key on the virtual number pad. Once the controllable object 106 is dragged to the target number key on the display interface 104, the user can select the target key by various approaches such as releasing his/her finger from the touch interface 110 immediately or a while later. In this way, numbers can be inputted to the display device 102 via the portable device 108.

In another example, when the user switches the portable device 108 to a text input mode, a virtual text keyboard is displayed on the display interface 104 of the display device 102. The user can move his/her finger on the touch interface 110 of the portable device 108 to drag the controllable object 106 displayed on the display interface 104 to a target letter/sign/character key of the virtual text keyboard. Once the controllable object 106 is dragged to the target letter/sign/character key on the display interface 104, the user can select the target letter/sign/character key by various approaches such as releasing his/her finger from the touch interface 110 immediately or a while later. In this way, text can be inputted to the display device 102 via the portable device 108.

In yet another example, when the user switches the portable device 108 to a list selection mode, a virtual list is displayed on the display interface 104 of the display device 102. The user can move his/her finger on the touch interface 110 of the portable device 108 to drag the controllable object 106 displayed on the display interface 104 to a target item of the virtual list. Once the controllable object 106 is dragged to the target item on the display interface 104, the user can select the target item by various approaches such as releasing his/her finger from the touch interface 110 immediately or a while later. If the target item is associated with a sub-list, the sub-list is displayed as soon as the controllable object 106 is moved to the target item, and the user can drag the controllable object 106 further to the new target item in the sub-list to select the new target item. If the user drags the controllable object 106 to another item of the virtual list, the displayed sub-list is hidden automatically. In this way, the user can select any item in the virtual list on the display device 102 via the portable device 108.

When the user switches the portable device 108 to a cursor control mode, the user is allowed to touch the touch interface 110 of the portable device 108 with a finger so as to smoothly and linearly (not grid by grid) move the controllable object 106 displayed on the display device 102. In this way, the user can easily select icons or an area on the display device 102 by moving the controllable object 106 freely.

When a user switches the portable device 108 to a gesture mode, the user can perform operations on the touch interface 110 of the portable device 108 with one or more fingers. The control software can convert the user's gesture into a control signal and then transmit the control signal to the display device 102 via the transmission unit 112, so the user can control an area or an object on the display interface 104 of the display device 102. For example, the user can touch the touch interface 110 of the portable device 108 with two fingers and spread or pinch the two fingers to zoom in or zoom out the object displayed on the display interface 104 of the display device 102. The user can also move the finger to write or draw on the touch interface 110 of the portable device 108, and the pattern written or drawn by the user can be directly displayed on the display interface 104 of the display device 102, so handwriting or drawing by hand can be performed. The user can also directly control an area or an object displayed on the display device 102 by tapping, dragging, and scrolling with the fingers touching the touch interface 110 of the portable device 108.

Besides, the user can make programmable settings such as storing favorite channels on the display device 102 by operating the portable device 108. Thus the user can perform various functions on the display device 102 by only operating the touch interface 110 of the portable device 108. And the portable device 108 can integrate various functions of different devices in the prior art without increasing the overall size of the portable device 108.

In another embodiment of the present invention, the user can control a plurality of display devices 102 by operating only one portable device 108. The user can also control speakers and many other devices with only one portable device 108. Thus the user does not need a plurality of remote controls to control a plurality of display devices 102 correspondingly. Instead the portable device 108 alone can be used to control a plurality of display devices 102, reducing the space occupied by many traditional remote controls.

The portable device 108 alone can be used to control a plurality of display devices, and the operation interface can be switched among different operation modes flexibly. Moreover, because the user often carries a smartphone, when the user needs to control a plurality of display devices, the user can easily use the smartphone to control the display devices without seeking various dispersed remote controls for corresponding devices, thereby saving time to look for other remote controls.

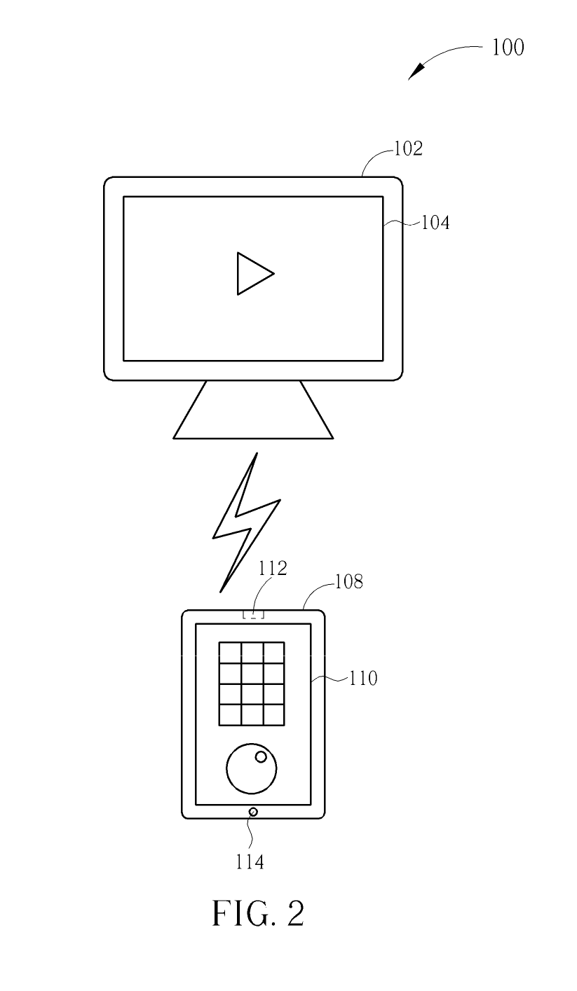

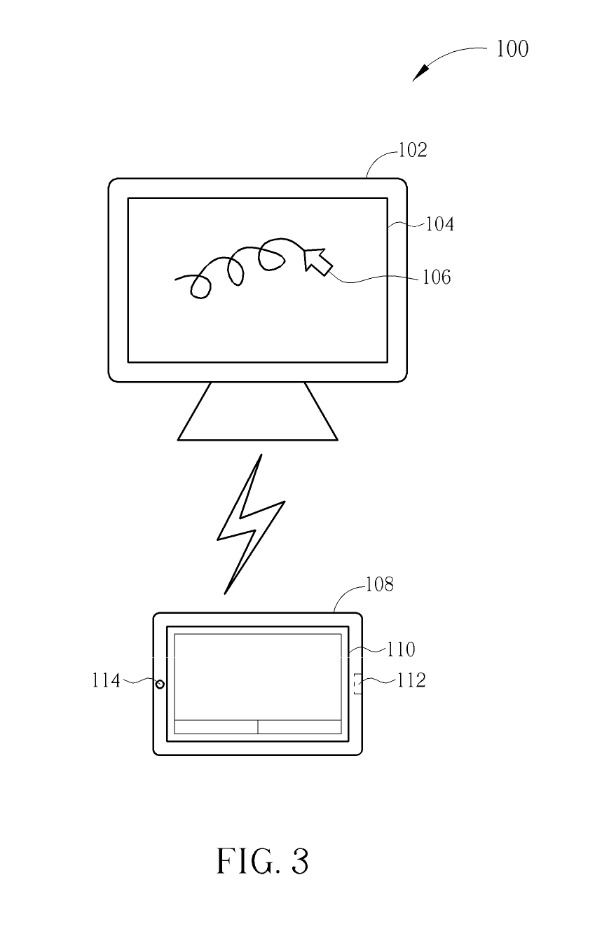

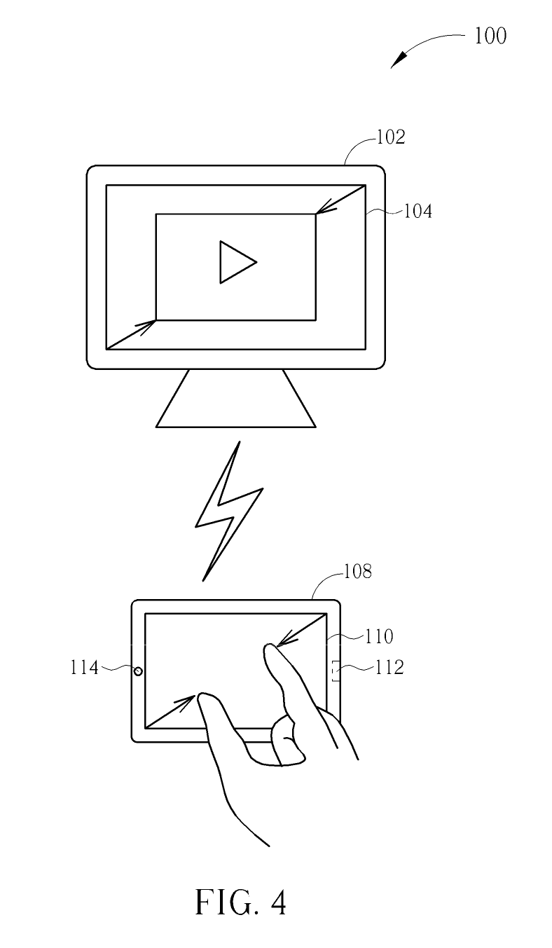

The operation mode of the portable device 108 can be switched to another operation mode whenever it is more appropriate. In an embodiment, the operation mode of the portable device 108 can be switched according to a display status of the display device 102. For example, FIG. 2 shows that when the display device 102 displays a TV program, the touch interface 110 of the portable device 108 is automatically switched to an A/V (audio/video) control mode so as to control the display device 102 to play a program, select a number, adjust the volume, select a channel, etc. In another embodiment, the operation mode of the portable device 108 can be switched according to an orientation of the portable device 108. FIG. 3 shows that when the portable device 108 is placed horizontally, the touch interface 110 of the portable device 108 is automatically switched to a touch panel mode. In another embodiment, the portable device 108 includes a button, and the user can push the button to switch the operation mode of the portable device 108. In yet another embodiment, the touch interface 110 of the portable device 108 displays an icon, and the user can switch the operation mode of the portable device 108 by touching the icon. FIG. 4 shows that the touch interface 110 of the portable device 108 controls the display device 102 in a gesture mode. After entering the gesture mode, the user can use one or more fingers to tap, drag, scroll, and/or handwrite on the touch interface 110 of the portable device 108 so as to generate a touch signal containing a position data that corresponding to a position of a touch point on the display interface 104 to operate the display device 102. Besides, the display interface 104 of the display device 102 and the touch interface 110 of the portable device 108 can display images synchronously.

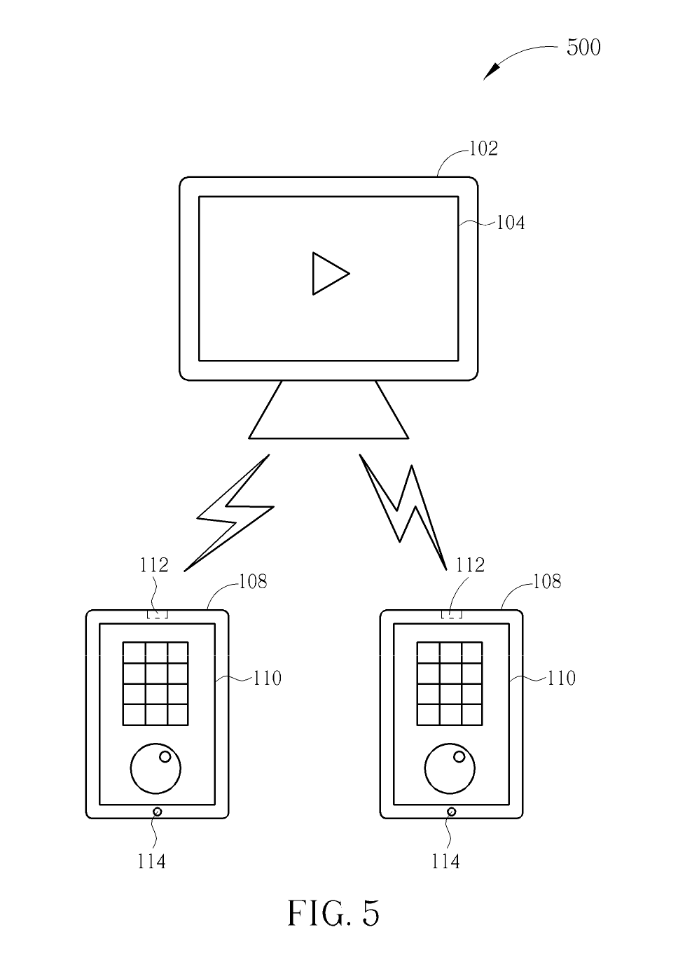

FIG. 5 shows a display control system 500 according to another embodiment of the present invention. The display control system 500 comprises the display device 102 (shown in FIG. 1) and two portable devices 108. In the display control system 500, the portable devices 108 can be used to control the same display device 102, and both of the two portable devices 108 can control the display device 102 in the same manner. However, the present invention further allows more than two portable devices 108 to control the same display device 102 in the same manner. For example, in FIG. 5 the two portable devices 108 are both in the A/V control mode, so both of the portable devices 108 can control the display device 102 to play a program, select a number, adjust the volume, switch a channel, etc.

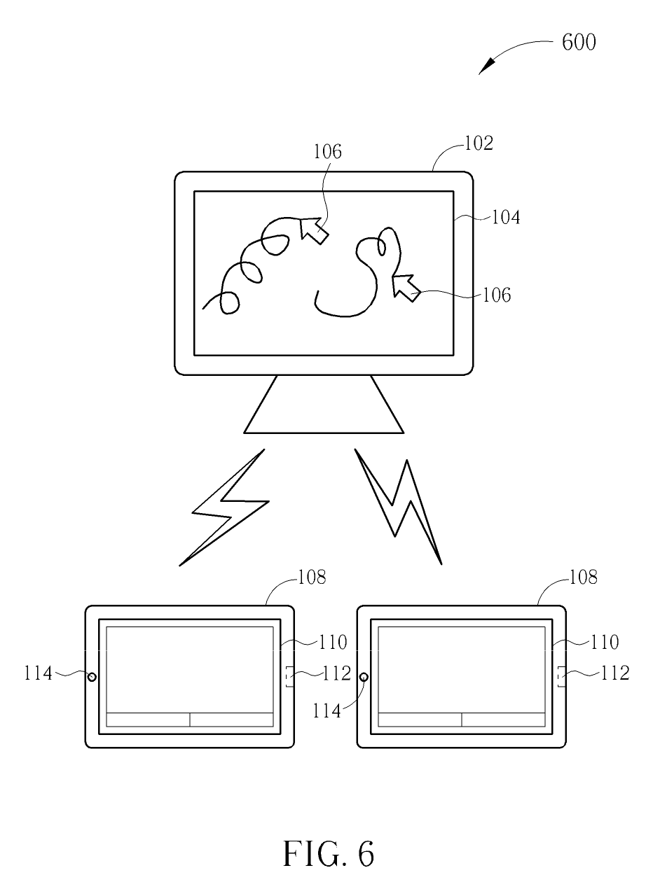

FIG. 6 shows a display control system 600 according to another embodiment of the present invention. The display control system 600 comprises the display device 102 shown in FIG. 1 and two portable devices 108. The display control system 600 is similar to the display control system 500, so the portable devices 108 can be used to control the same display device 102. However, what makes the display control system 600 different is that the two portable devices 108 shown in FIG. 6 are both in the touch panel mode, hence each of the two portable devices 108 can be used to independently control a corresponding controllable object 106 shown on the display interface 104 of the display device 102. For example, the two or more controllable objects 106 can be two or more cursors or two or more characters of a video game, and each of them can be controlled independently by a corresponding portable device 108.

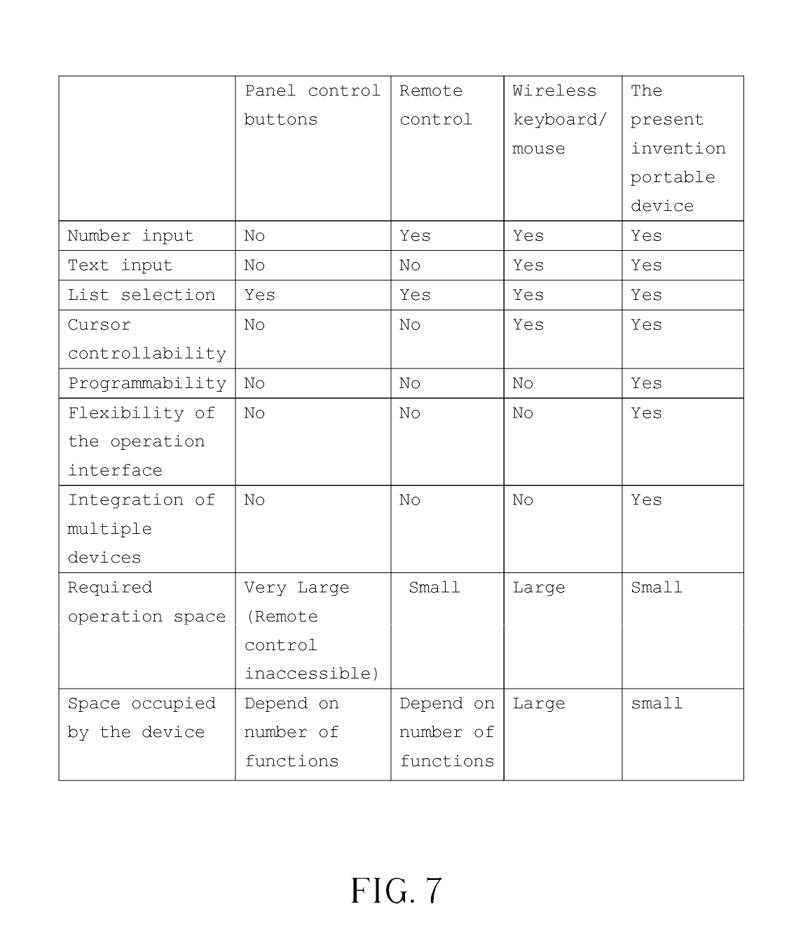

In conclusion, the display control systems in the embodiments of the present invention provide user friendly interfaces to make controlling a display device an easy task. For instance, a user is able to tap, drag, scroll and handwrite on the portable device so as to control the display device. That is, the user can intuitively move his/her finger(s) on the touch interface of the portable device to control the display device. Moreover, the present invention allows one or more users to control a display device directly with one or more portable devices such as smartphones without using any remote control to save space. FIG. 7 lists a comparison between the portable device of the present invention and prior art control devices. FIG. 7 shows that the portable device of the present invention overcomes many shortcomings of the prior art and integrates many functions of various control devices into one single portable device. This effectively increases functions of the touch interface of the portable device without occupying additional space. The portable device in the present invention not only allows a user to key in numbers or enter text into the display device, it also allows the user to select an item in a list to operate the display device by triggering directional keys. By controlling the movement of a cursor like a mouse, the user can enter any types of data to the display device. Besides, the portable device of the present invention can be customized according the user's request. For example, the user can set favorite channels, use one portable device to control a plurality of display devices, etc. That is, the controls of multiple display devices can be integrated into a single portable device. Because the portable device can be switched to another operation mode whenever it is appropriate, no extra buttons are required and thus occupying no additional space. Further since the portable device can be implemented with a smartphone, it is highly portable, and can be operated when a wireless network is available, greatly increasing an operable distance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display control system for controlling a display device comprising a display interface having a controllable object, comprising:
a communication unit configured to transmit voice signals to third party communication devices and receive voice signals from said third party communication devices;
a touch interface configured to generate a touch signal containing a position data that corresponding to a touch point on the display interface; and
a transmission unit connected with the touch interface and being configured to transmit the touch signal to the display device for moving the controllable object on the display interface to a position that corresponding to the position of the touch point on the touch interface.

2. The display control system as claimed in claim 1, wherein the portable device is a cellular phone or a wireless keyboard.

3. The display control system as claimed in claim 1, wherein the controllable object is a cursor.

4. The display control system as claimed in claim 1, wherein the touch signal is triggered by a tap, a drag, a scroll and/or a handwriting movement.

5. The display control system as claimed in claim 1, wherein the display device and the portable device perform wireless communications via Wi-Fi, Bluetooth, infrared, or an Ethernet network.

6. The display control system as claimed in claim 1, wherein the portable device further includes a button configured to switch an operation mode of the portable device.

7. The display control system as claimed in claim 1, wherein the touch interface includes a touch panel, and the touch panel displays an icon configured to switch an operation mode of the portable device.

8. A method for controlling a display device with a display interface displaying a controllable object, the method comprising:
generating, by at least one portable device, a touch signal containing a position data that corresponding to a position of a touch point on the display interface; and
receiving the touch signal, on the display device, to move the controllable object on the display interface to a position that corresponding to the position of the touch point on the touch interface.

9. The method as claimed in claim 8, wherein the touch signal is generate by two portable device to control the display device.

10. The method as claimed in claim 8 further comprising switching an operation mode of the portable device according to a display status of the display device.

11. The method as claimed in claim 8 further comprising switching an operation mode of the portable device according to an orientation of the portable device.

12. The method as claimed in claim 8 further comprising switching an operation mode of the portable device after a button or an icon of the portable device is triggered.

13. The method as claimed in claim 8 further comprising controlling the display interface and a touch panel of the portable device to display images synchronously.
